(19) United States
(12) Patent Application Publication
(10) Pub. No.: US 2026/0161289 A1
(43) Pub. Date: Jun. 11, 2026

(54) SUPPORTING CRYPTOGRAPHIC OPERATIONS ASSOCIATED WITH A SERIAL MEMORY INTERFACE

(71) Applicant: Cypress Semiconductor Corporation, San Jose, CA (US)

(72) Inventors: Sandeep Amarthaluru, Bangalore (IN); Karthikeyan Logaswamy, Coimbatore (IN)

(73) Assignee: Cypress Semiconductor Corporation, San Jose, CA (US)

(21) Appl. No.: 18/977,417

(22) Filed: Dec. 11, 2024

(51) Int. Cl. G06F 3/06; H04L 9/06; H04L 9/08

(52) U.S. Cl. CPC G06F 3/061; G06F 3/0656; G06F 3/0673; H04L 9/0631; H04L 9/0816

(57) ABSTRACT

A memory address corresponding to encrypted data communicated via a serial memory interface (SMIF) is determined by a processing device to be within a range of memory addresses corresponding to a computed key stored in a key cache. An exclusive or (XOR) operation is performed on the encrypted data and the computed key to generate plain text corresponding to the encrypted data in response to determining the memory address is within the range of memory addresses corresponding to the computed key.

### TECHNICAL FIELD

The present disclosure relates generally to the field of cryptography, and more particularly, to a key cache for supporting cryptographic operations associated with a serial memory interface (SMIF).

### BACKGROUND

Serial communication refers to communication in which information is transferred sequentially one bit at a time. A serial memory interface (SMIF) may refer to a multifunction hardware block that implements serial communication. For example, a SMIF may implement serial peripheral interface (SPI) communication to external serial memory devices, such as NOR (NOT-OR) flash, static random access memory (SRAM), and non-volatile SRAM. Serial Peripheral Interface (SPI) is a standard (with many variants) for synchronous serial communication, used primarily in embedded systems for short-distance wired communication between integrated circuits.

Some SMIFs may support execute-in-place (XIP) access to memory. XIP can refer to a method of executing programs directly from long-term storage rather than copying it into RAM. It is an extension of using shared memory to reduce the total amount of memory required. The general effect of XIP is that the program text consumes no writable memory, saving it for dynamic data, and that all instances of the program are run from a single copy.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates exemplary aspects of a computing device according to some embodiments of the current disclosure.

FIG. 2 illustrates various aspects of generating a computed key according to some embodiments of the current disclosure.

FIG. 3 illustrates various aspects of input data for generating a computed key according to some embodiments of the current disclosure.

FIG. 4 illustrates various aspects of supporting cryptographic operations associated with a SMIF according to some embodiments of the current disclosure.

FIG. 5 illustrates an exemplary logic flow for supporting cryptographic operations associated with a SMIF according to some embodiments of the current disclosure.

### DETAILED DESCRIPTION

The following description sets forth numerous specific details such as examples of specific systems, components, methods, and so forth, in order to provide a good understanding of various embodiments of the techniques described herein for supporting cryptographic operations associated with a SMIF. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Existing serial interfaces, such as SMIFs, fail to efficiently support cryptographic operations, such as for XIP. A key may be recomputed for each byte of data despite the same key being utilized to decode multiple bytes of data, leading to excessive and unnecessary calculations. For example, a block cipher may be utilized to generate computed keys for each memory address accessed in a byte-by-byte manner (e.g., based on byte-by-byte instructions); the computed keys, however, may be valid for a range of memory addresses. This leads to inefficient operation because resources are expended to compute the same key for each memory address in a range of memory addresses. These challenges and complexities oftentimes result from existing systems failing to efficiently support cryptographic operations with sufficient or desirable memory resources. For example, existing systems may not include memory (e.g., a hardware cache) that is available or practical (e.g., secure, low latency, etc.) to facilitate the reuse of computed keys for a range of memory addresses. These limitations can drastically reduce the usability of existing systems with serial interfaces, contributing to inefficient systems, devices, and techniques with limited capabilities.

Embodiments of the present disclosure address the above and other problems by including a key cache along with logic to prevent a computed key from being recomputed while the computed key is still usable. In several embodiments, these techniques may be utilized to reduce the number of times cipher text (e.g., a computed key) is generated for performing on-the-fly decryption. In many embodiments, the cache may include a hardware cache configured to store computed keys to enable more efficient generation of plain text. For example, a computed key may remain the same for a range of memory addresses. Accordingly, embodiments disclosed hereby may include a key cache for storing a computed key as well as logic to reuse the computed key, instead of recomputing it, for each memory address in the range of memory addresses. In other words, a computed key may be generated once for the entire set of memory addresses that can be decrypted using the computed key.

In these and other ways, components/techniques described hereby may provide many technical advantages. For example, embodiments may improve the efficiency of cryptographic operations, such as decryption operations, by enabling the reuse of computed keys. In another example, embodiments may enable cryptographic operations when memory is accessed based on byte-by-byte instructions. In yet another example, embodiments may enable support for cryptographic operations in XIP modes of operation. Thus, the computer-based techniques of the current disclosure improve cryptographic operations associated with serial interfaces as compared to conventional approaches. Further, embodiments disclosed hereby can be practically utilized to improve the functioning of a computer and/or to improve a variety of technical fields including cryptography, serial communication, XIP, and memory devices.

The illustrative examples and embodiments provided above are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

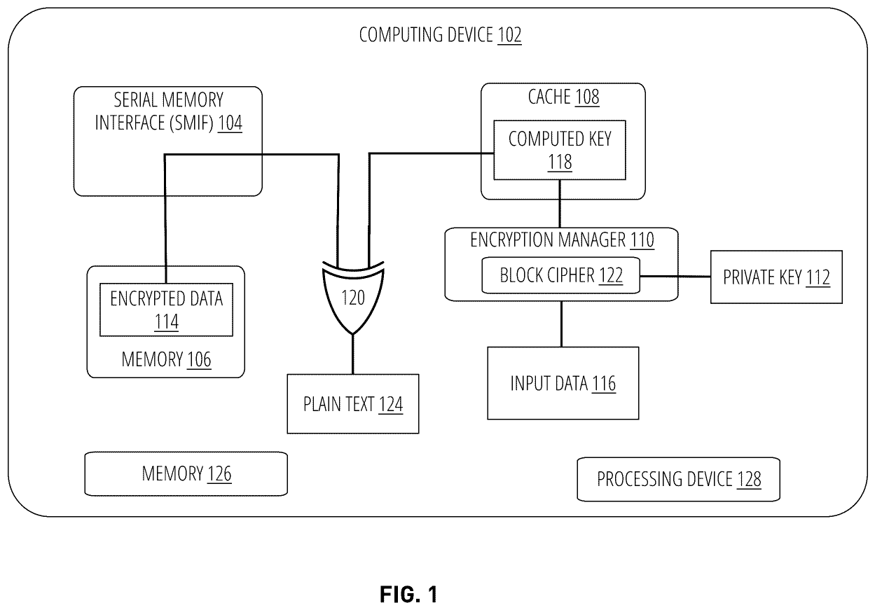

FIG. 1 illustrates exemplary aspects of a computing device 102 according to some embodiments. In the illustrated embodiment, computing device 102 includes a SMIF 104, a memory 106, cache 108, exclusive or (XOR) logic 120, encryption manager 110 with block cipher 122, memory 126, and processing device 128. The illustrated components of computing device 102 may interoperate to support efficient cryptographic operations associated with data stored in memory 106 and accessed via SMIF 104. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, one or more components of computing device 102, such as cache 108, encryption manager 110, XOR logic 120, and/or block cipher 122 may be included in SMIF 104 and/or processing device 128 without departing from the scope of this disclosure. Embodiments are not limited in this context.

According to embodiments described hereby, the computing device 102 may utilize cache 108 to perform cryptographic operations in a more efficient manner, such as by generating plain text 124 in a more efficient manner. The cache 108 may include a hardware cache configured to store computed keys to enable more efficient generation of plain text. In various embodiments, the computed key 118 may include cipher text that can be XOR'ed with corresponding encrypted data to generate plain text. For example, a cryptographic operation may be initiated to convert encrypted data 114 in memory 106 into plain text 124. In several embodiments, this operation may be performed as part of an XIP access through SMIF 104, such as an on-the-fly decryption. As part of this operation, encryption manager 110 may determine whether the memory address of encrypted data 114 is included in a range of memory addresses corresponding to computed key 118. More generally, the encryption manager 110 may include logic (e.g., in a processing device) to determine whether the computed key stored in 108 can be utilized to decrypt the encrypted data 114 (e.g., via XOR logic 120) and whether a new computed key needs to be generated.

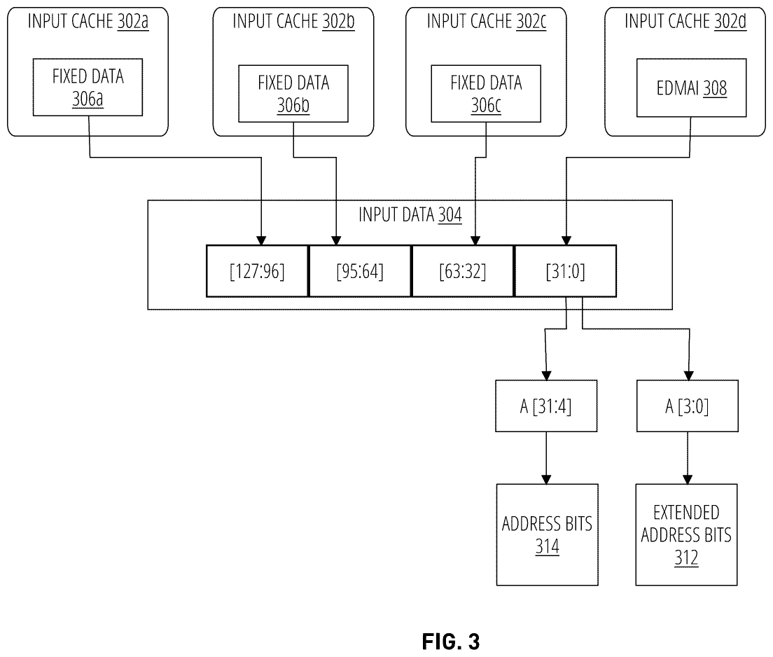

In some embodiments, the encryption manager 110 may determine whether the memory address of encrypted data 114 is included in a range of memory addresses corresponding to computed key 118 based on input data 116. For example, as will be discussed in more detail below, such as with respect to FIG. 3, input data 116 may include data corresponding to a memory address of encrypted data 114. In many embodiments, the encryption manager 110 may compare the memory address (e.g., a SMIF address) of encrypted data 114, or a portion thereof, with data indicative of a range of memory addresses corresponding to computed key 118. In various embodiments, encryption manager 110, or another component, may cause data indicative of the range of memory addresses corresponding to computed key 118 to be stored. For example, in one embodiment, data indicative of the range of memory addresses corresponding to computed key 118 may be stored in the cache 108.

If the memory address of encrypted data 114 is included in the range of memory addresses corresponding to computed key 118, then encryption manager 110 may cause an exclusive or operation to be performed on the computed key 118 and the encrypted data 114 by XOR logic 120 to generate plain text 124. If the memory address of encrypted data 114 is not included in the range of memory, however, then encryption manager 110 may cause a new computed key to be generated by block cipher 122 and stored in cache 108 as computed key 118. Each new computed key may be generated by block cipher 122 based on input data 116 and private key 112. The new computed key may be stored in cache 108 as computed key 118. The encryption manager 110 may then cause an exclusive or operation to be performed on the new computed key 118 and the encrypted data 114 by XOR logic 120 to generate plain text 124. This process may be repeated as needed to access encrypted data stored on memory 106.

In various embodiments, the block cipher 122 may include a symmetric key algorithm. In various such embodiments, the symmetric key algorithm may operate on a 128-bit block of data (e.g., input data 116) using a 128-bit, 192-bit, or 256-bit cryptographic key (e.g., private key 112) to generate a 128-bit block of output data (e.g., computed key 118). In some embodiments, the symmetric key algorithm may include or utilized the advanced encryption standard (AES). Accordingly, block cipher 122 may include an AES-128 forward block cipher.

The memory 106 may be communicatively coupled to other components of the computing device 102 via the SMIF 104. More generally, the SMIF 104 may implement at least some instances of serial communication in computing device 102. For example, the memory 106 may include a serial memory device, such as dynamic random access memory (DRAM) and the SMIF 104 may implement serial peripheral interface (SPI) communication with the memory 106. Accordingly, in many embodiments, memory 106 may include, or refer to, memory accessed by computing device 102 via SMIF 104. The memory 126, on the other hand, may refer to memory of computing device 102 that is not accessed via SMIF 104. In some embodiments, memory 106 may refer to external memory and memory 126 may refer to internal memory. In some embodiments, one or more of the illustrated components of computing device 102, such as the components utilized to implement the techniques disclosed hereby, may be included in a memory or interface device, such as a SMIF. In some such embodiments, this memory or interface device may be included in a larger computing device or system, such as a microcontroller unit or a system on a chip.

It should be noted that various components may be described and illustrated as separate for simplicity or clarity of description, however, one or more of these components may be combined or shared without departing from the scope of this disclosure. For example, although a single processing device is depicted in computing device 102 for simplicity, other embodiments may include multiple processing devices, storage devices, or other components. For example, SMIF 104, XOR logic 120, or block cipher 122 may include separate processing devices that implement various aspects of the techniques described hereby. The processing device 128 and/or other processing devices may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In many embodiments, the processing device 128 and/or other processing devices may also include one or more special-purpose processing devices such as an application specific integrated circuit (ASIC), a field programmable gate array (FPGA), a digital signal processor (DSP), network processor, a system on chip (SOC), a micro controller, or the like.

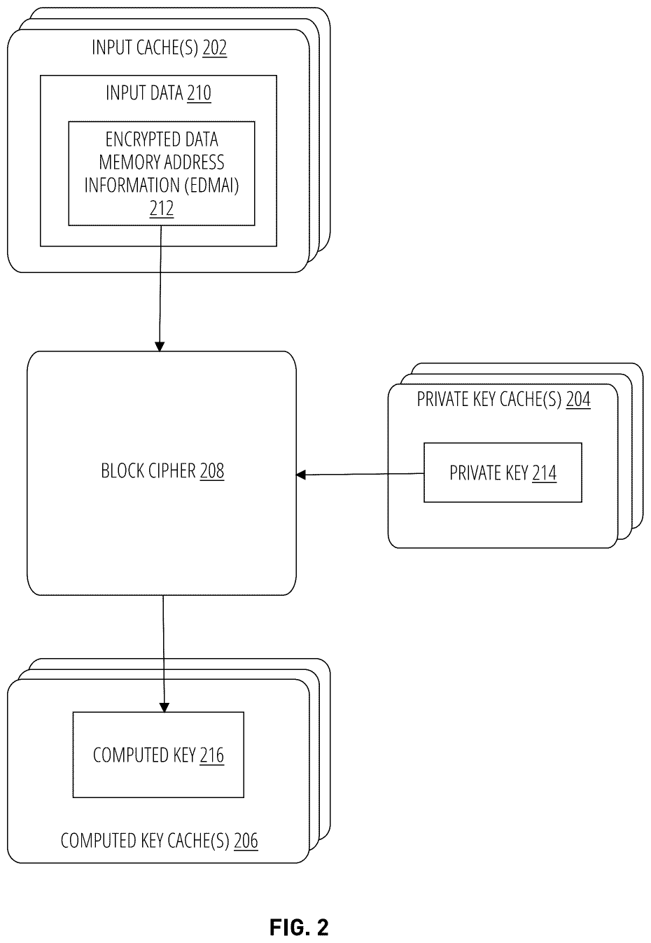

FIG. 2 illustrates various aspects of generating a computed key 216 according to some embodiments. The illustrated embodiment includes one or more input caches 202, one or more private key cache 204, one or more computed key cache 206, and block cipher 208. The block cipher 208 may generate computed key 216 based on the contents of the one or more input caches 202 and the contents of the one or more private key cache 204. The computed key 216 may be stored in the one or more computed key cache 206 for subsequent use in performing efficient cryptographic operations on memory accessed via a serial interface, such as a SMIF. One or more components of FIG. 2 may be the same or similar to one or more other components disclosed hereby. For example, computed key cache 206 may be the same or similar to cache 108. In another example, block cipher 208 may be the same or similar to block cipher 122. In yet another example, input data 116 may be the same or similar to input data 210. Further, aspects discussed with respect to various components in FIG. 2 may be implemented by one or more other components from one or more other embodiments without departing from the scope of this disclosure. For example, input caches 202, private key cache 204, computed key caches 206, and/or block cipher 208 may be implemented by computing device 102 without departing from the scope of this disclosure. Embodiments are not limited in this context.

As previously mentioned, the techniques described hereby enable more efficient cryptographic operations. This is achieved, at least in part, by the inclusion of the computed key cache 206. More specifically, the computed key cache 206 may be utilized to prevent the recomputation of a key for each memory address, such as when a CPU generates instructions byte by byte, resulting in more efficient cryptographic operations. For example, multiple memory addresses may utilize the same computed key and computed key cache 206 can be utilized for storage and reuse of the same computed key for each of the multiple memory addresses. In contrast, existing systems recompute the same computed key for each access to one of the multiple memory addresses for which the computed key is valid.

In many embodiments, the computed key cache 206 includes a hardware cache. In many such embodiments, the hardware cache may be included in a dynamic random access memory device. It will be appreciated that, for simplicity, each of the caches 202, 204, 206 are generally referred to in the singular despite the possibility of being implemented as multiple caches. For example, input cache 202 may store 16 bytes of data in four separate four-byte caches. In another example, computed key cache 206 may store 16 bytes of data in four separate four-byte hardware caches. In one embodiment, the computed key cache 206 may include an indication of the range of memory addresses that the computed key 216 is valid for.

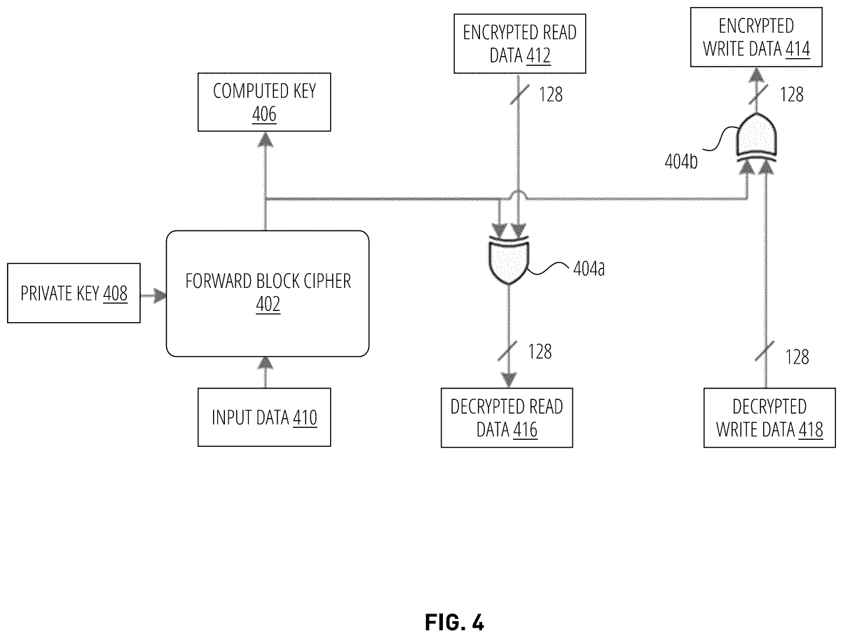

The block cipher 208 may utilize the contents of the input cache 202 and the private key cache 204 to generate computed key 216. For example, the input data 210 may include encrypted data memory address information (EDMAI) 212. The EDMAI 212 may include, among other things, the memory address of data that is the target of a decryption operation (e.g., encrypted data 114). In some embodiments, the EDMAI 212 may be utilized to determine whether or not a new computed key needs to be generated. As discussed in more detail below, such as with respect to FIG. 4, only a portion of the EDMAI 212 may be utilized to generate the computed key 216. This portion of the EDMAI 212 may correspond to the range of addresses that the computed key 216 corresponds to. For example, the portion of the EDMAI 212 utilized by the block cipher 208 to generate the computed key 216 may include the n most significant bits in the memory address while the i least significant bits are disregarded (e.g., i=4 and n=28 for a 32-bit address). Accordingly, the range of memory addresses that the n most significant bits correspond to may indicate the range of memory addresses that the corresponding computed key is valid for.

In several embodiments, the block cipher 208 may include a symmetric key algorithm that calculates the computed key 216 based on the input data 210 and the private key 214. In various such embodiments, the symmetric key algorithm may operate on a 128-bit block of input data (e.g., input data 210) using a 128-bit, 192-bit, or 256-bit cryptographic key (e.g., private key 214) to generate a 128-bit block of computed key data (e.g., computed key 216). In various embodiments, the computed key 216 may include cipher text that can be XOR'ed with corresponding encrypted data to generate plain text. In some embodiments, the symmetric key algorithm may include or utilized the advanced encryption standard (AES). In some such embodiments, block cipher 208 may include an AES-128 forward block cipher.

FIG. 3 illustrates various aspects of input data 304 for generating a computed key according to some embodiments. The illustrated embodiment includes input caches 302a, 302b, 302c, 302d (collectively referred to as input caches 302). The first input cache 302a includes fixed data 306a, the second input cache 302b includes fixed data 306b, the third input cache 302c includes fixed data 306c, and the fourth input cache 302d includes encrypted data memory address information (EDMAI) 308. Collectively the data in the input caches 302 form input data 304 including address bits 314 and extended address bits 312. As previously mentioned, the input data 304 may be utilized along with a cryptographic key to generate a computed key that can be XOR'ed with corresponding encrypted data to generate plain text. One or more components of FIG. 3 may be the same or similar to one or more other components disclosed hereby. For example, input caches 302 may be the same or similar to input cache 202. In another example, input data 304 may be the same or similar to input data 116. Further, aspects discussed with respect to various components in FIG. 3 may be implemented by one or more other components from one or more other embodiments without departing from the scope of this disclosure. Embodiments are not limited in this context.

Although other sizes are possible without departing from the scope of this disclosure, FIG. 3 is illustrated and described with respect to input data 304 that comprises 128-bits or 16-bytes. Further, each of the input caches 302 store 4-bytes. In some embodiments, the contents of input caches 302 may be concatenated to create input data 304. Accordingly, input data 304 includes four blocks of 4-bytes (or 32-bits). The first block corresponds to the contents of input cache 302d and includes bits [31:0] of input data 304, the second block corresponds to the contents of input cache 302c and includes bits [63:32] of input data 304, the third block corresponds to the contents of 302b and includes bits [95:64] of input data 304, and the fourth block corresponds to the contents of first input cache 302a and includes bits [127:96] of input data 304. Thus, the 12 most significant bytes may comprise fixed data and the four least significant bytes may include the memory address information for the encrypted data.

The second, third, and fourth blocks of the input data 304 include fixed data. The fixed data may be utilized to configure the cipher block, select a mode, ensure proper block size, and the like. For example, the input data 304 may include nonce values that pad the input data 304 to ensure the input to the block cipher is 16-bytes. The first block of the first input cache 302a includes EDMAI 308 (e.g., the address information). In various embodiments, the address information may include the memory address of the encrypted data that is sought to be decrypted. The address information in input data 304 includes the address bits 314 and the extended address bits 312. The address bits 314 may be utilized in the generation of a computed key, but the extended address bits 312 may not be utilized in the generation of a computed key. Accordingly, the computed key may be the same for each memory address that includes address bits 314.

In many embodiments, the address bits 314 and extended address bits 312 may include, or indicate, the entire memory address for encrypted data (e.g., address of encrypted data 114 on memory 106). Further, since the computed key is the same for all values of the extended address bits 312, the address bits 314 may indicate a range of memory addresses for which the computed key is valid and can be used to decrypt data in the range of memory addresses. For example, if the CPU is trying to read from address 0x80000000 to 0x800000FF, 0x800000 is used by the block cipher to generate the computed key, resulting in the computed key for 0x80000000 to 0x800000FF being the same. In various embodiments, the 28 most significant bits of the memory address information for the encrypted data may be utilized to generate computed keys and/or for determining whether a memory address corresponding to the encrypted data is within a range of memory addresses corresponding to the computed key. In many embodiments, the determination of whether a memory address corresponding to encrypted data is within a range of memory addresses corresponding to a computed key and/or whether a new computed key needs to be generated. may be implemented via logic circuitry, such as logic circuitry included in a processing device.

FIG. 4 illustrates various aspects of supporting cryptographic operations associated with a SMIF according to some embodiments. The illustrated embodiment includes a forward block cipher 402, a first XOR gate 404a, a second XOR gate 404b, and data inputs/outputs including computed key 406, a private key 408, input data 410, encrypted read data 412, encrypted write data 414, decrypted read data 416, and decrypted write data 418. In various embodiments, these components and data inputs/outputs may be utilized to generate the computed key 406, the decrypted read data 416, and/or the encrypted write data 414. One or more components of FIG. 4 may be the same or similar to one or more other components disclosed hereby. For example, forward block cipher 402 may be the same or similar to block cipher 208. In another example, input data 410 may be the same or similar to. Further, aspects discussed with respect to various components in FIG. 4 may be implemented by one or more other components from one or more other embodiments without departing from the scope of this disclosure. For example, encrypted read data 412 may be received from memory 106 via SMIF 104 without departing from the scope of this disclosure. In another embodiment, computed key 406 may be received from cache 108 without departing from the scope of this disclosure. Embodiments are not limited in this context.

In various embodiments, the forward block cipher 402 may generate computed key 406 based on private key 408 and input data 410. For example, forward block cipher 402 may include an AES-128 forward block cipher that takes private key 408 as a 128 bit block and input data 410 as a 128 block as inputs to a cryptographic algorithm that outputs the computed key 406. In various embodiments, the computed key 406 may be stored in a cache, such as a hardware cache.

In many embodiments, the decrypted read data 416 may be generated by passing the computed key 406 and the encrypted read data 412 through XOR gate 404a. For example, when it is determined that the computed key 406 corresponds to the encrypted read data 412, the computed key 406 may be XOR'ed with encrypted read data 412 via XOR gate 404a to generate decrypted read data 416. In some embodiments, the decrypted read data 416 may be further processed, such as by a CPU. In some embodiments, the encrypted write data 414 may be generated by passing the computed key 406 and the decrypted write data 418 through the XOR gate 404b.

It will be appreciated that the layout and configuration of components in FIG. 4 is exemplary and a variety of alternative layouts and configurations may be utilized without departing from the scope of this disclosure. For example, some configurations may utilize a single XOR gate.

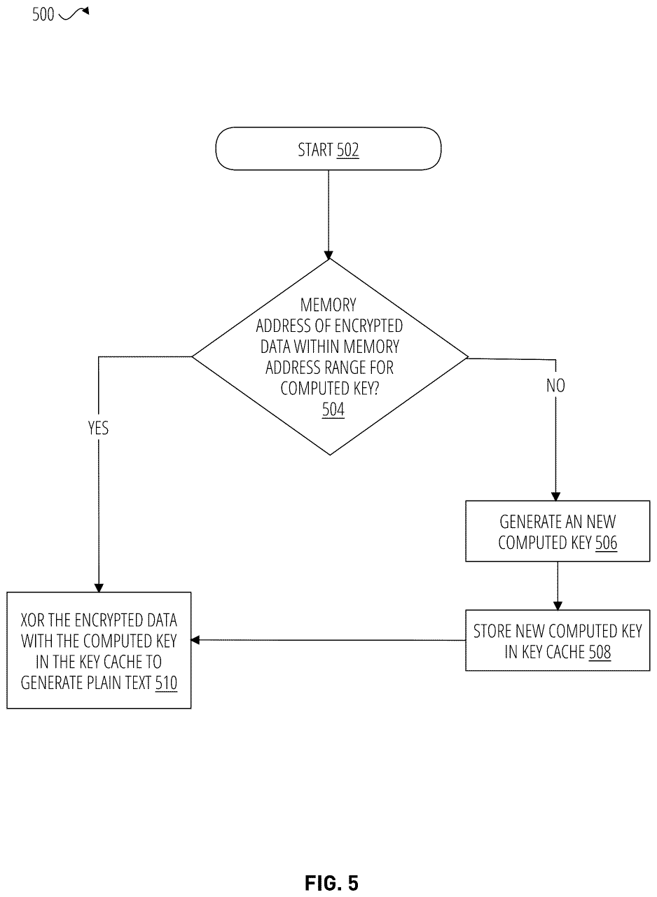

FIG. 5 illustrates a logic flow 500 for supporting cryptographic operations associated with a SMIF according to some embodiments. The logic flow 500 may be performed by processing logic that may include hardware and/or control logic (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of logic flow 500 may be performed by one or more components of computing device 102, SMIF 104, block cipher 122, XOR logic 120, encryption manager 110, and/or processing device 128. Embodiments are not limited in this context.

With reference to FIG. 5, logic flow 500 illustrates example functions used by various embodiments. Although specific function blocks (“blocks”) are disclosed in logic flow 500, such blocks are examples. That is, embodiments are well suited to performing various other blocks or variations of the blocks recited in logic flow 500. It is appreciated that the blocks in logic flow 500 may be performed in an order different than presented, and that not all of the blocks in logic flow 500 may be performed.

Logic flow 500 begins at start block 502. From start block 502, the logic flow 500 proceeds to decision block 504 where it is determined whether the memory address of encrypted data is within a memory address range for a computed key. For example, encryption manager 110 may determine whether the memory address of encrypted data 114 is within a memory address range corresponding to computed key 118. In some embodiments, this determination may be made based on input data 116, as discussed previously. For example, the memory address of encrypted data 114, or a portion thereof, included in input data 116 may be compared with data indicative of a range of memory addresses corresponding to computed key 118.

If the memory address of the encrypted data is within the memory range for the computed key, then the logic flow 500 proceeds to block 506. At block 506 a new computed key is generated. For example, block cipher 208 may generate computed key 216 based on private key 214 and input data 210 corresponding to the encrypted data. Proceeding to block 508, the new computed key may be stored in a key cache. For example, the new computed key may replace the previous computed key, such as computed key 118 in the cache 108.

Next, the logic flow 500 proceeds to block 510. Additionally, referring back to decision block 504, if the memory address of the encrypted data is within the memory range for the computed key, then the logic flow 500 proceeds to block 510. At block 510 the encrypted data may be XOR'ed with the computed key in the key cache to generate plain text. For example, XOR gate 404a may be utilized to XOR computed key 406 and encrypted read data 412 to generate decrypted read data 416.

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” “various embodiments”, and the like means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” “various embodiments”, and the like in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “performing”, “computing,” “storing,” or the like, refer to the actions and processes of a processing device, an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes at least one of A or B” or “X includes A or B” is intended to mean any of the natural inclusive permutations. That is, if X includes A; X includes B; or X includes both A and B, then “X includes at least one of A or B” or “X includes A or B” is satisfied under any of the foregoing instances. Similarly, “X includes one or more of A and B” should be interpreted the same as “X includes at least one of A or B”. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as a wireless communication device including at least one of an end device, a client device, a station (STA), an access point, a router, or a co-ordinator) for performing the operations herein. This apparatus may be specially constructed for the required purposes, or it may comprise firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments. Further, a “computer-readable medium” or “computer-readable storage medium” may be non-transitory.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
determining, by a processing device, a memory address corresponding to encrypted data communicated via a serial memory interface (SMIF) is within a range of memory addresses corresponding to a computed key stored in a key cache; and
performing an exclusive or (XOR) operation on the encrypted data and the computed key to generate plain text corresponding to the encrypted data in response to determining the memory address is within the range of memory addresses.

2. The method of claim 1, wherein the key cache comprises a hardware cache.

3. The method of claim 2, wherein the hardware cache is included in a dynamic random access memory chip.

4. The method of claim 1, wherein the encrypted data is communicated via the SMIF as part of an execute-in-place (XIP) operation.

5. The method of claim 1, wherein the computed key comprises cipher text.

6. The method of claim 1, wherein the range comprises 16 bytes of memory.

7. The method of claim 1, wherein the computed key is computed based on a symmetric key algorithm.

8. The method of claim 7, wherein the symmetric key algorithm comprises an advanced encryption standard algorithm.

9. The method of claim 1, wherein the memory address comprises a first memory address, the encrypted data comprises first encrypted data, the computed key comprises a first computed key, and the method further comprising:
determining a second memory address corresponding to second encrypted data communicated via the SMIF is outside the range of memory addresses that correspond to the first computed key stored in the key cache;
computing a second key based on the second encrypted data to produce a second computed key; and
storing the second computed key in the key cache.

10. A micro controller comprising:
a cache; and
a processing device coupled to the cache, the processing device configured to:
determine a memory address corresponding to encrypted data communicated via SMIF is within a range of memory addresses corresponding to a computed key stored in the cache; and
perform an exclusive or (XOR) operation on the encrypted data and the computed key to generate plain text corresponding to the encrypted data in response to determining the memory address is within the range of memory addresses.

11. The micro controller of claim 10, wherein the cache comprises a hardware cache.

12. The micro controller of claim 11, wherein the hardware cache is included in a dynamic random access memory chip.

13. The micro controller of claim 10, wherein the encrypted data is communicated via the SMIF as part of an execute-in-place (XIP) operation.

14. The micro controller of claim 10, wherein the computed key comprises cipher text.

15. The micro controller of claim 10, wherein the range comprises 16 bytes of memory.

16. The micro controller of claim 10, wherein the computed key is computed based on a symmetric key algorithm.

17. The micro controller of claim 16, wherein the symmetric key algorithm comprises an advanced encryption standard algorithm.

18. A system on chip (SOC) device comprising:
a hardware cache;
a serial memory interface (SMIF) configured to:
determine a memory address corresponding to encrypted data communicated via the SMIF is within a range of memory addresses corresponding to a computed key stored in the hardware cache; and
perform an exclusive or (XOR) operation on the encrypted data and the computed key to generate plain text corresponding to the encrypted data in response to determining the memory address is within the range of memory addresses.

19. The SOC device of claim 18, wherein the computed key is computed based on a symmetric key algorithm.

20. The SOC device of claim 18, wherein the hardware cache is included in a dynamic random access memory chip.
